(19) United States
(12) Patent Application Publication
(10) Pub. No.: US 2006/0293847 A1
(43) Pub. Date: Dec. 28, 2006

(54) Interactive scaling feature having scalability in three dimensional space

(76) Inventors: Graham H. Marriott, Los Angeles, CA (US); Lawrence Zempel, Los Angeles, CA (US); Matt Kuehl, Los Angeles, CA (US); Cameron Hickey, Chicago, IL (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/159,497

(22) Filed: Jun. 22, 2005

(51) Int. Cl. G01C 21/32

(52) U.S. Cl. 701/212

(57) ABSTRACT

A system and method for controlling the scale of an image is disclosed, which comprises an image object in a graphical user interface. A ruler object provides a ruler display for distance measurement in the image. A button object comprising the ruler detects a cursor event that is sent to the image object for processing changes in the scale of the image responsive to the cursor event. Further disclosed is a system and method to provide directional orientation in an electronic map. Data is stored that indicates local perceptions of north, south, east and west for regions on the map. When each region is displayed, the system provides a toggle for switching between displaying the region with true north at an angle of 0 degrees orientation, or displaying the region at an angle with the local perception of north at an angle of 0 degrees orientation.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Use of electronic maps has become commonplace in everyday life of many people. For example FIG. 1, illustrates one type of prior art electronic map that is provided over the Internet. The user typically requests that the system display a regional part of the electronic map, or region 10, by typing in an address, or point of interest 8, that is identified with a star or other icon in the region 10 to be displayed. The electronic map searches for the region 10 and displays it on a graphical user interface, such as a browser widow 100. This type of electronic map is commonly employed by users that are planning a trip to a particular location. The region 10 of the map that is displayed can be scaled up or down as desired so that the user may become familiar with the surrounding street names and locations to avoid getting lost. The scaling is usually performed via one or more push-button objects 12 on the interface 100. Once the push-button is pressed, the browser window 100 disappears, and re-draws itself at an angle that has been pre-selected in the system. This provides a very discontinuous and “choppy” scaling feature as shown in the system of FIG. 1. If the user was trying to focus on a particular object or street name, for example, in the region, the focus would be lost when the map disappears and re-draws itself. Further, the scale selections are pre-selected in the system, and often, when the next available scale resolution is selected, it is either too large or too small for proper viewing of the object on which the user is trying to focus.

With respect to the type of electronic map displayed on the Internet in accordance with FIG. 1, the displayed region 10 is typically viewed with the region's north direction directed straight up, or at 0 degrees offset, from the 12 o'clock position. While selectable arrows 14 may be selected using a pointing device to scroll across the displayed region 10, there typically is not a means to provide more comprehensive manipulation of display of the region 10.

Accordingly, there is a need for a system that is capable of providing smoother and more comprehensive manipulation of electronic maps and other images. The claimed invention clearly addresses this and other needs.

### BRIEF SUMMARY OF THE INVENTION

Briefly, and in general terms, the claimed invention resolves the above and other problems by providing a system and method for controlling the scale of an image, which comprises an image object in a graphical user interface. A ruler object provides a ruler display for distance measurement in the image. A button object detects a cursor event on the ruler. The cursor event is sent to the image object for processing changes in the scale of the image responsive to the cursor event, thus, interconnecting the functions of the image and the ruler. A plurality of cursor events are triggered by a user's dragging the position of a pointing device along the ruler.

In accordance with another aspect of a preferred embodiment, the system is capable of handling any type of image. Some types of images that can be used with the system include, by way of example only, and not by way of limitation, electronic maps, engineering diagrams, anatomical images, blue prints, architectural works, circuit diagrams, mechanical images, interior design layouts, photographs, artworks, word processing files, text files, and video files.

In accordance with another aspect of a preferred embodiment, the system provides an electronic map presented in a graphical user interface, having an interactive ruler object for controlling the scale of the map. A ruler object provides a ruler display for distance measurement on the map. An invisible button object is provided for detecting cursor events on the ruler, the map comprising a map object, the cursor events for sending to the map object for processing changes in the scale of the map responsive to the cursor events.

In accordance with another aspect of a preferred embodiment, a system and method provides for changing distance markers on a ruler for an electronic map. In this embodiment, the electronic map comprises a Flash® MovieClip object. A plurality of events are detected for changing the scale of the electronic map. For each event, the system determines whether the event comprises a request for a scale change. For each event, scaling the map is performed according to an amount requested in the event. Scaling the ruler is performed according to the amount requested in the event. For each event, a determination of the measurement scale and placement of distance marks is performed, which depends on the resulting scale of the map. For each event for which the ruler scale was changed, the distance marks on the ruler are drawn, or redrawn, according to the determined measurement scale. In one embodiment, the denomination of the distance indicators for the marks on the ruler are changed at predetermined scale changes.

In accordance with another aspect of a preferred embodiment, at least one of the events is received as a result of manipulation by a user of a graphical button in a graphical user interface in which the map is displayed. The button sends the at least one event when a user changes position of the button to request a scale change. The change of position by the user comprises dragging the position of the button along a portion of the graphical user interface to request a scale change, the button sending a plurality of events as a result of such dragging, with each of the plurality of events indicating a substantially consecutive change in the scale of the map. In one embodiment, the button comprises, or is coexistent with, the ruler, wherein the ruler responds to one or more mouse events on the ruler.

In accordance with another aspect of a preferred embodiment, a system and method is provided to provide directional orientation in an electronic map. Data is stored that indicates local perceptions of north, south, east and west for regions on the map. The local perceptions are related to the regions. When each region is displayed, the system provides a toggle for switching between displaying the region with true north at an angle of 0 degrees orientation, or displaying the region at an angle with the local perception of north at an angle of 0 degrees orientation. At least one of the stored local perceptions of north is based on the named directions of local streets in the relative region. The stored local perceptions comprise an offset angle to define an angle of offset from north displayed at 0 degrees at which to display the region.

### BRIEF DESCRIPTION OF THE DRAWINGS

FIG. 1 is an example of a prior art online mapping system according to one prior art system;

FIG. 2 is a diagrammatic illustration of a system and method for controlling the scale of an image, which comprises an image object, and an integrated ruler and scale object, in a graphical user interface according to one embodiment;

FIG. 3 is a diagrammatic illustration of the system of FIG. 2, scaled after the user has clicked and dragged a cursor arrow on the ruler to change the scaling of the region;

FIG. 4 is a flow diagram illustrating steps performed by software and/or hardware in an embodiment of the claimed invention to process scale events;

FIG. 5 is a flow diagram illustrating further steps performed by software and/or hardware in an embodiment of the claimed invention to process scale events in a graphical user interface using a pointing device;

FIG. 6 is a flow diagram illustrating a preferred method for providing directional orientation in an electronic map; and

FIG. 7 is another flow diagram illustrating steps performed by one embodiment of the claimed invention to provide directional orientation in an electronic map.

### DETAILED DESCRIPTION OF THE PREFERRED EMBODIMENTS

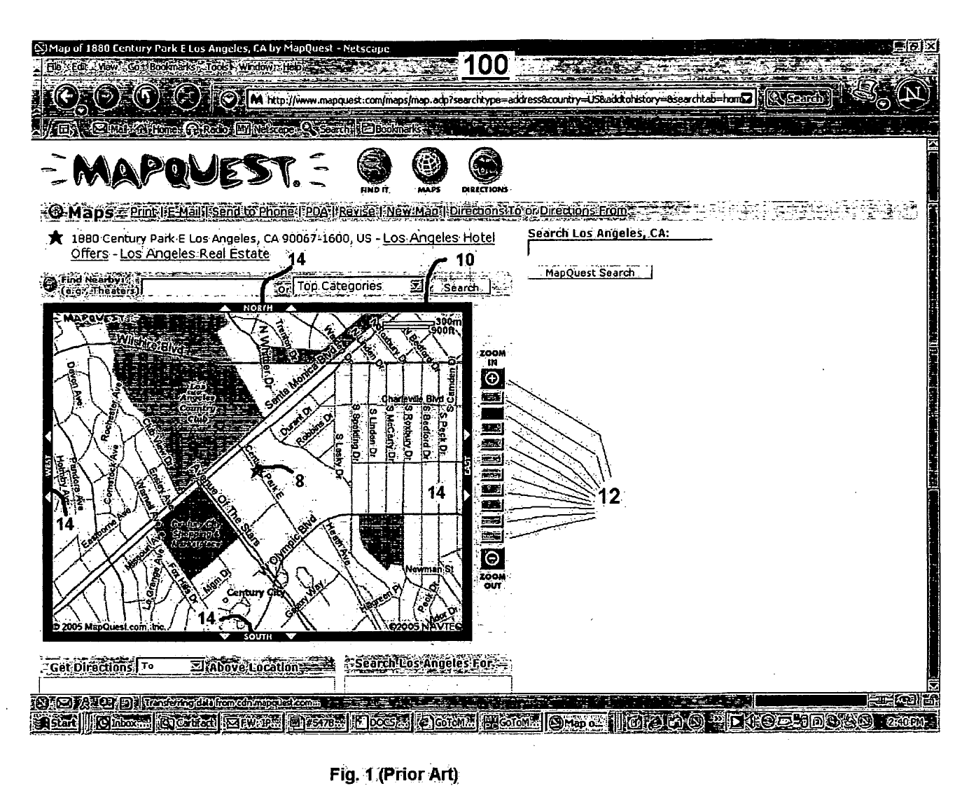

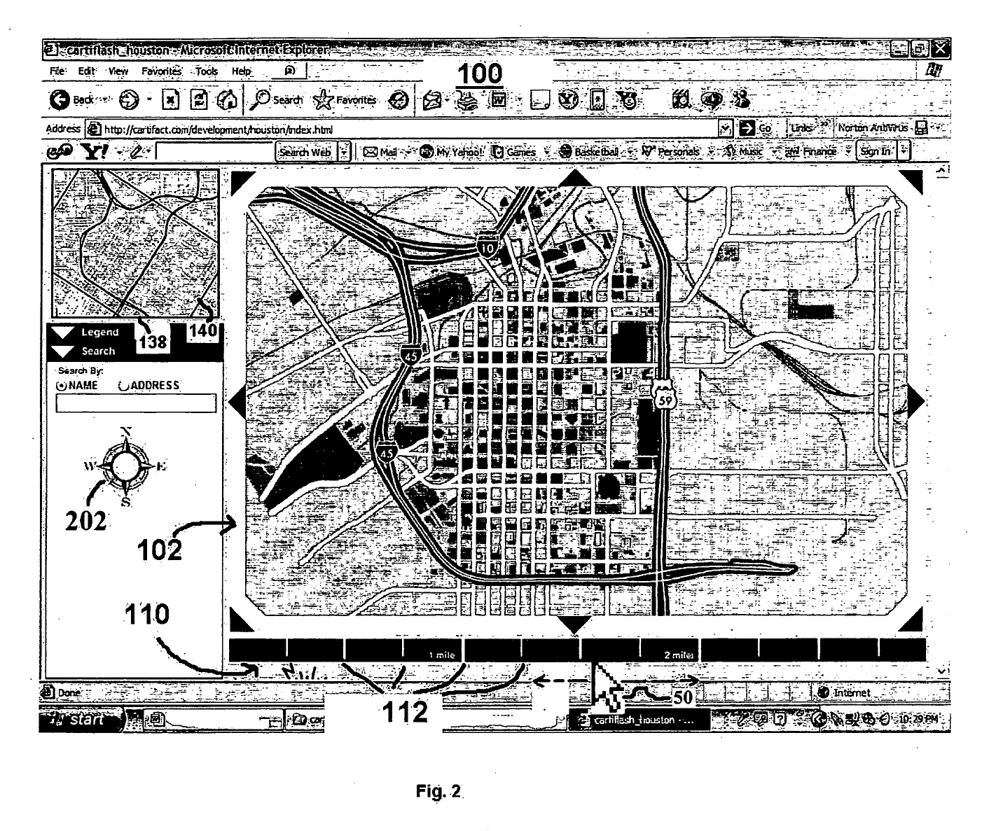

Referring now to the drawings, wherein like reference numerals denote like or corresponding parts throughout the drawings and, more particularly to FIGS. 1-7, there is shown one embodiment of an image manipulation system constructed in accordance with the claimed invention. Specifically, with respect to a preferred embodiment shown in FIG. 2, a preferred embodiment of the claimed invention provides a system and method for controlling the scale of an image 102, which comprises an image object in a graphical user interface 100. A ruler object provides a ruler display 110 for distance measurement in the image 102. A button object, which is an “invisible” (i.e., transparent) button that runs the length of the ruler display 110, detects a cursor event on the ruler 110. The cursor event is sent to the image object for processing changes in the scale of the image 102 responsive to the cursor event. A plurality of cursor events are triggered by a user's dragging the position of a pointing device 50 along the ruler 110. In the embodiment of FIG. 1, the image 102 comprises an electronic map. However, in another preferred embodiment, the system is capable of handling any type of image 102. Examples of types of images that can be used with the system, without limitation, include electronic maps, engineering diagrams, anatomical images, blue prints, architectural works, circuit diagrams, mechanical images, interior design layouts, photographs, artworks, word processing files, text files or video.

In FIG. 2, the system provides an electronic map 102 presented in a graphical user interface 100, having an interactive ruler object for controlling the scale of the map 110. The ruler object provides a ruler display 110 for distance measurement on the map 102. An invisible button object is provided for detecting cursor events on the ruler, the map 108 comprising a map object, the cursor events for sending the map object for processing changes in the scale of the map responsive to the cursor events.

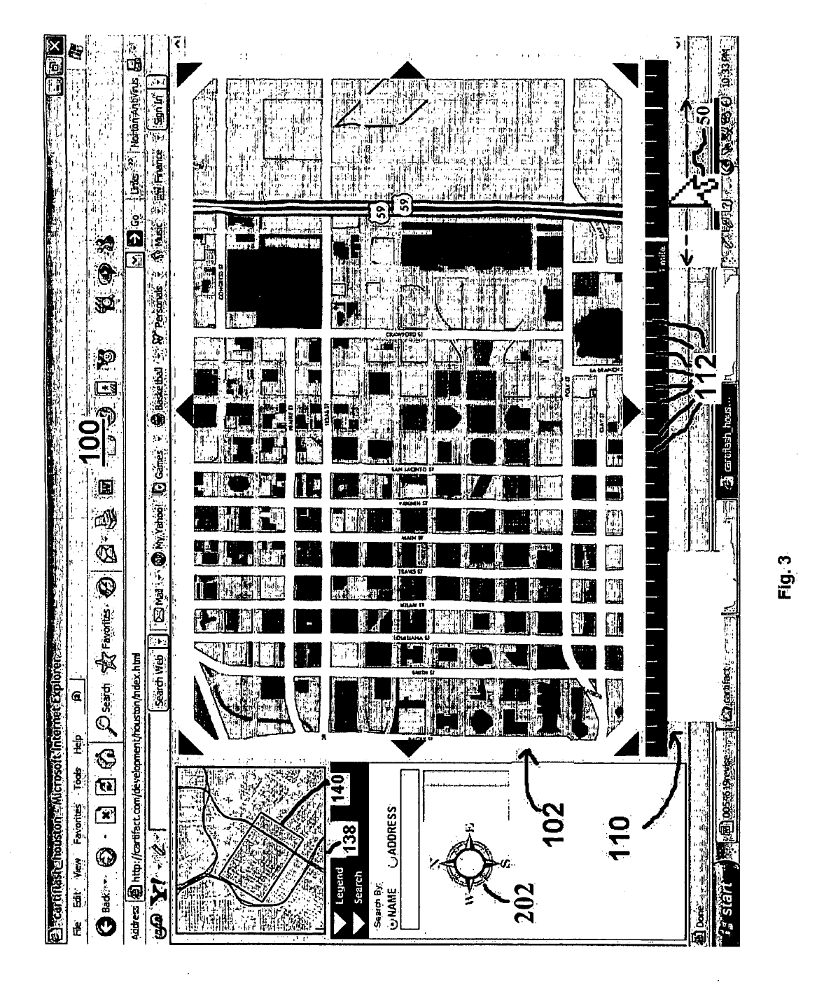

With reference to FIG. 3, the region 102 of FIG. 2 is shown, scaled after the user has clicked and dragged the cursor arrow 50 on the ruler 110 to change the scaling of the region 102. As the user is drags the arrow 50 on the ruler 110, the distance marks 112 become farther apart as the scale is zoomed in to see greater detail. For example, the “1 mile” and “2 mile” distance marks 112 have smoothly and fluidly become farther apart as the user drags the arrow 50. Further, at predetermined scale resolutions, distance marks 112 are added between the quarter mile distance marks for more accurate measuring of distances at zoomed-in scales. The extra distance marks 112 are added and taken away as the scale is zoomed in and out.

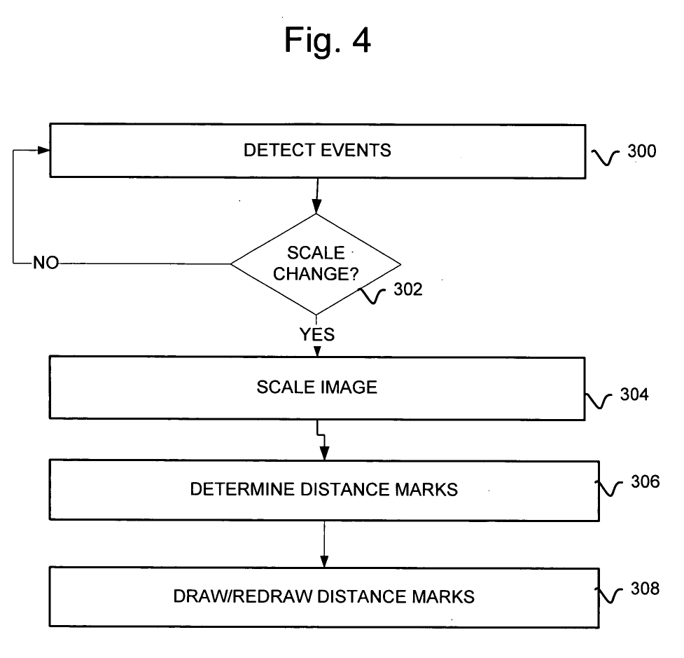

With reference to FIG. 4, a flow diagram illustrates the steps performed in system software and/or hardware of one preferred embodiment of the claimed invention. A system and method is provided for changing distance markers 112 (as shown in FIG. 2) on the ruler 110 for an image. The image 102 comprises a Flash® MovieClip object. A plurality of events are detected for the image 102, step 300. For each event, the system determines whether the event comprises a request for a scale change, step 302. For each event, scaling of the image is performed according to an amount requested in the event, step 304. Scaling the ruler is performed according to the amount requested in the event. For each event, a determination of the measurement scale and placement of distance marks is performed, step 306, which depends on the resulting scale of the image 102. For each event for which the ruler scale was changed, the distance marks on the ruler are drawn or redrawn, according to the determined measurement scale, step 308. The denomination of the distance indicators for the marks on the ruler are changed at predetermined scale changes, step 106. For example, the system may be configured to label quarter mile indicators at scales that show regions less than five miles across, tenth mile indicators at scales that show regions less than one mile across, and the like.

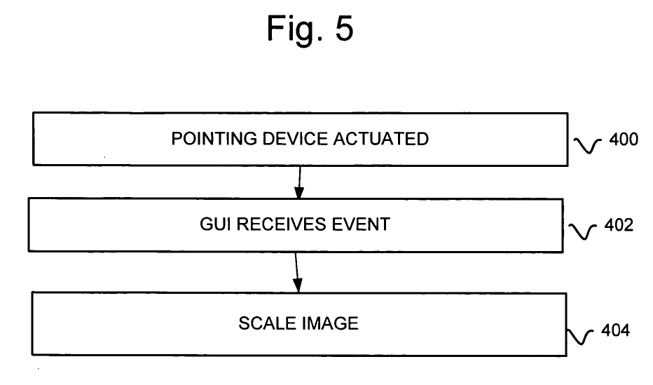

With reference to FIG. 5, a flow diagram illustrates further steps performed by software and/or hardware to process events in a preferred embodiment of the claimed invention. The user manipulates or actuates the pointing device, step 400. As a result, at least one of the events is received in a graphical user interface 100 (the button is coexistent with the ruler display 110 in FIG. 2), step 402. The button sends the at least one event to the image object when a user changes position of the button (or in the case of the embodiment of FIG. 2, clicks or drags the pointing device 50 on the ruler 110) to request a scale change, which is effected by the image object, step 404.

In one preferred embodiment, the change of position by the user comprises dragging the position of the button along a portion of the graphical user interface (the ruler 110 as shown in FIG. 2) to request a scale change, the button sending a plurality of events as a result of such dragging, each of the plurality of events indicating a substantially consecutive change in the scale of the image 102. In one embodiment, the button comprises, or is coexistent with, the ruler 110, wherein the ruler 110 responds to one or more mouse events on the ruler 110. A mouse event is an event in a system that results from any activity of the mouse.

In one embodiment, the scaling function is implemented as a set of distinct Flash® MovieClips or MovieClip objects. One MovieClip object implements the image 102, which can send and receive events, including scale events, namely scaleRelative(scalepercent), and setScale(scaleval). Another MovieClip object, namely the ScaleRuler MovieClip, sends these scale events to the image object.

In one embodiment, the ruler object comprises two parts, the button and the displayed ruler 110. The button is an invisible (or transparent) rectangle that is the full size of the ruler 110, and it responds to mouse actions (e.g., rollover, press, release). When the user clicks and drags the button/ruler 110, the computer code determines the direction of the drag, and creates scale events to either increase or decrease the scale. These scale events send a message to both the image object and ruler object to cause them to increase or decrease their size by an amount relative to the change in position of the button. The ruler object queries the image object before drawing the ruler display 110 to determine the exact width of the image (in real distance units-feet) so that it can determine how many distance marks 112 to draw.

Below is pseudo code (directed toward a map-image embodiment) describing the software and/or hardware implementation. In the image object, the following function is called every instant that a scale event is received from the ruler object. The function performs 4 tests:
Is the current scale less the maximum allowed scale, and
Is the requested scale percent change greater than or equal to 100 (decimal 1)
   or
Is the scale greater than the minimum allowed scale, and
Is the requested scale percent change less than or equal to 100 (decimal 1)
   If these conditions are met:
The status of map motion is set to “scale”
The scale function scales the MovieClip which contains the image object (trans_mc) by the amount requested in both x and y axes.
The map receives an event that is has moved, so that it can redraw any components which may need redrawing.

The following actual computer code implements the pseudo code for the image 102.

public function scaleRelative(scalepercent:Number) {

if (

(

(trans_mc._xscale<=scaleMax) && (scalepercent>=1)

) ∥ (

(trans_mc._xscale>=scaleMin) && (scalepercent<=1)

)
)

{

this._statusObj.motion = “scale”;
trans_mc._xscale *= scalepercent;
trans_mc._yscale *= scalepercent;
this.onMapMove( );

}

}

In the ruler object, the pseudo code is implemented using the following computer code according to one embodiment:

public function updateScaleSegments( ):Void {

var segDegree:Number = 8;
var mapCW:Number = map.getCurrentFrame( ).getWidth( );
var cUnit:Number = 5280; // the current unit of scale
var numUnits:Number = mapCW/cUnit;
var unitLimit:Number = 1; // number of miles before smaller
lines are hidden
var finalLimit:Number = 7;
var unitW:Number = w/numUnits;
segs.lines.removeMovieClip( );
var lines:MovieClip = segs.createEmptyMovieClip(“lines”,21);
var depth = 10;
for (var i:Number=0;i<numUnits;i++) {

var thisLine:MovieClip =
lines.createEmptyMovieClip(“L_”+i,depth++);
var currP:Number = i * unitW;
var top:Number = 0;
var bottom:Number = h;
drawSegLine(top,bottom,currP,thisLine,0xFFFFFF,4);
// LABEL THE MILE LINES
if ((i>0) && (currP<(map.getWindowW( )+10))) {

labelThisLine(i);

}
var segMultiple = Math.floor( segDegree *
(unitLimit/numUnits) );
if (segMultiple>finalLimit) {segMultiple=finalLimit;}
for (var j:Number=0;j<segMultiple;j++) {

var numSubSegs:Number = Math.pow(2,j);
var segWidth = unitW/numSubSegs
var startP = (segWidth/2) + (currP);
for (var k:Number = 0;k<numSubSegs;k++) {

var t = (j+1)*3 //− 4;
var b = h − t;
var p = (startP + (segWidth*k));
var segDepth = depth + ((j+1)*(k+ 1));
var segLine:MovieClip =
lines.createEmptyMovieClip(“L_”+i+“_”+j+“_”+k ,
depth++);
var c:Number = OxFFFFFF;
var thick:Number = (3 − (j )) + .5;
if (p<w) {drawSegLine(0,b,p,segLine,c,thick);}

}

}

}

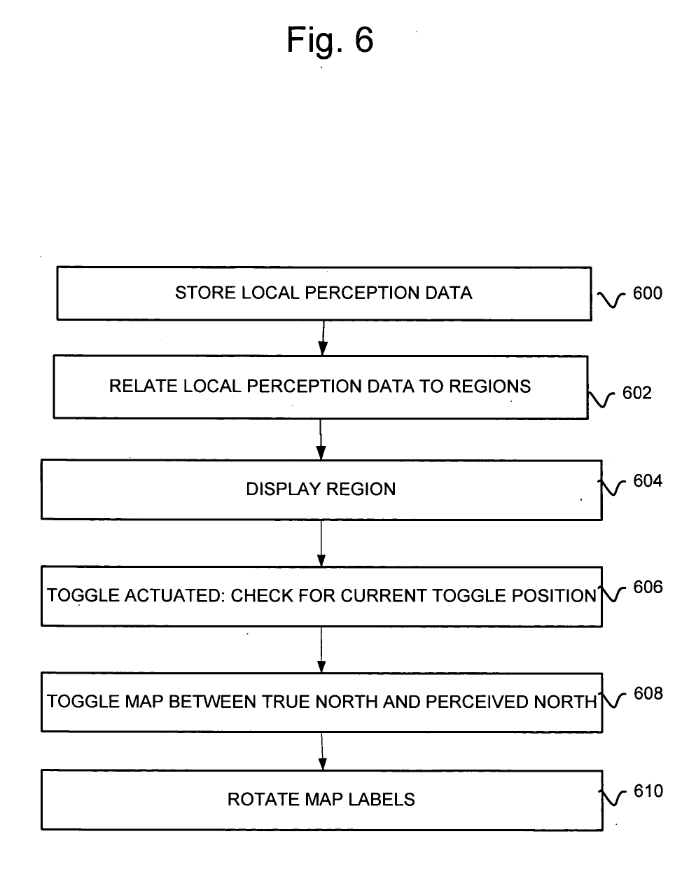

With reference back to FIG. 2, and now FIG. 6 (flow diagram), in another preferred embodiment of the claimed invention, a system and method is provided to provide directional orientation in a region of an electronic map 102. Especially in mobile mapping systems, a compass orients the user to true north. The claimed system of the invention adds functionality to orient the user to a commonly shared understanding of north/south & east/west for local markets or regions. Data is stored in a data store that indicates local perceptions of north, south, east and west for regions on the map 102, step 600. In one embodiment, the data store comprises disk space on a remote web server from which the system operates, or in another embedment, local storage on a local mapping system within a vehicle or hand held mapping device, or the like. The local perceptions are related to the regions, step 602, which may be identified by GPS coordinates in the data store, or other standard cartographic region identifiers. At least one of the stored local perceptions of north is based on the named directions of local streets in the relative region. The stored local perceptions comprise an offset angle to define an angle of offset from north displayed at 0 degrees at which to display the region. When each region is displayed, step 604, the system provides a toggle for switching between displaying the region with true north at an angle of 0 degrees orientation, or displaying the region at an angle with the local perception of north at an angle of 0 degrees orientation. When the toggle is actuated, the system checks for whether the map is currently toggled to the true north position, or the local perception of north position, step 606. The map is toggled to either true north or perceived north, depending on the current toggle, step 608. Map labels rotate based on the rotation angle, step 610.

In FIGS. 2 and 3, the map image region 102 is shown angled with the local perceived north direction at 0 degrees. As can be seen in FIG. 2, the streets that are perceived to run north-south appear as if they actually do run north-south according to cartographic standards that dictate that north on a map points up at 0 degrees. However, this particular region 102 is shown in FIG. 1 with true north at an offset of approximately 45 degrees. This can be readily seen on the browser interface 100 via an offset illustration region 138 in the upper left-hand corner. When the region 102 is shown with the perceived north at 0 degrees, the same region is illustrated in smaller scale in area 138, but with true north at 0 degrees. A rectangle 140 bounds the region shown in area 102, which serves to visually illustrate the offset. In one embodiment, when true north of the region 102 is toggled to 0 degrees in area 102, the region 140 may be illustrated with perceived north at 0 degrees in screen area 138 so that screen area 138 serves as a preview area for the toggle.

In one embodiment, instead of using a toggle, an on-screen map compass 202 (FIGS. 2 and 3) can be free-rotated to rotate the map region 102 by dragging on a compass point with the pointing device, using a rotating cursor movement to cause the map region 102 to rotate to a desired angle (as the text labels auto-adjust to face upright). The free rotation function of the rotation compass 202 is based on two components, the visible rotation compass, or wheel 202, and an invisible button.

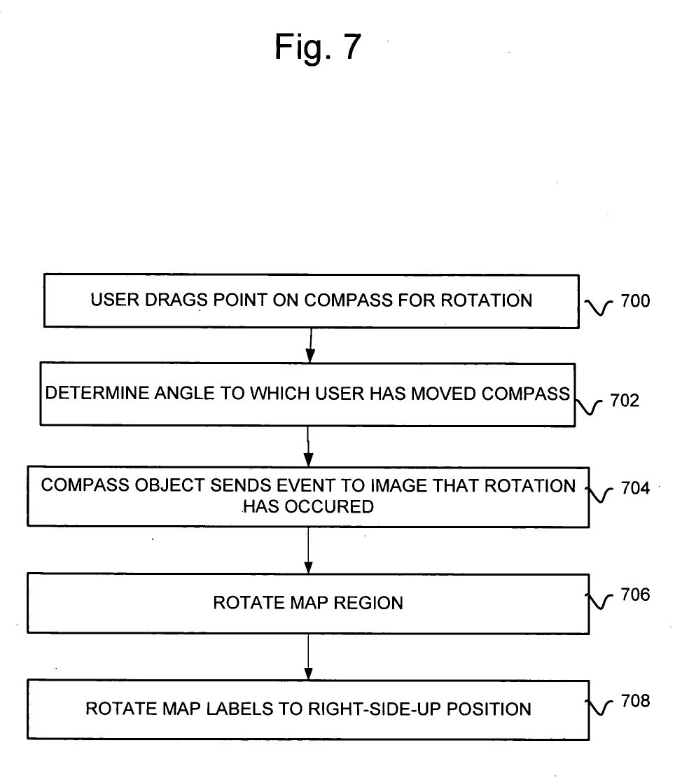

With reference to FIG. 7, a flow diagram illustrates the steps performed by software and/or hardware to effect image rotation. When the user clicks and drags on the rotation compass 202, step 700, by virtue of clicking and dragging a point, an internal calculation based on a trigonometric function, a Tan 2( ), determines the angle that the user has moved the underlying button, step 702, and sends events to both the visible rotation compass 202, and the image 102 to display the rotation. When the rotation is complete, an event is sent to the image 102 that informs the image object that rotation has occurred, step 704. The map then rotates itself to the angle indicated in the event, step 706. The image object checks the rotation of each visible label, re-rotating if each label necessary so that the words are right-side up, step 708.

In one embodiment, the following computer code may be used in the image object of for image 102 to implement this feature:

public function rotateTo(angle:Number):Void {

this._statusObj.motion = “rotate”;
trans_mc._rotation = angle;

}

In one embodiment, the following computer code is used in the object for the compass wheel 202 to implement this feature:

handle.onEnterFrame = function( ) {
if (this.isrotating) {

// determine the current angle
var currX = this._x;
var currY = this._y;
var rotationAngle = Math.atan2(currX,currY);
var rDeg = 180 − (rotationAngle/(Math.PI/180));
// rotate the actual map based on the current position

_global.map.rotateTo(rDeg);

compass.icon._rotation = rDeg;
compass.currentRotation = rDeg;

}

}

Although the invention has been described in language specific to computer structural features, methodological acts, and by computer readable media, it is to be understood that the invention defined in the appended claims is not necessarily limited to the specific structures, acts, or media described. Therefore, the specific structural features, acts and mediums are disclosed as exemplary embodiments implementing the claimed invention.

Furthermore, the various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for controlling the scale of an image, comprising:
a ruler object, wherein the ruler object provides a ruler display for distance measurement in the image; and
a button object, wherein the button object detects a cursor event on the ruler, the image comprising an image object, the cursor event, wherein the cursor event is for sending to the image object for processing changes in the scale of the image responsive to the cursor event;
wherein the image object and the real object are linked such that a change in one object causes a corresponding change in the other object.

2. The system of claim 1, wherein a plurality of cursor events are triggered by dragging a position of a pointing device along the ruler.

3. The system of claim 1, wherein the image consists of a type selected from group of: electronic maps, engineering diagrams, anatomical images, blue prints, architectural works, circuit diagrams, mechanical images, interior design layouts, photographs, artworks, word processing files, text files, and video.

4. The system of claim 2, wherein, for each event, the ruler object further provides a re-drawn distance marker responsive to the changes in scale of the image, thereby providing for a smooth transition of the ruler as the scale of the image changes.

5. A method for making a smooth transition in changing distance markers on a ruler for an image, the method comprising:
(a) detecting a plurality of events for changing the scale of the image;
(b) for each event, determining whether the event comprises a request for a scale change;
(c) for each event, scaling the image according to an amount requested in the event;
(d) for each event, scaling the ruler according to the amount requested in the event;
(e) for each event, determining the measurement scale and placement of distance marks depending on the resulting scale of the image; and
(d) for each event, drawing the distance marks on the ruler.

6. The method of claim 5, wherein at least one of the events is received as a result of manipulation by a user of a graphical button in a graphical user interface in which the image is displayed.

7. The method of claim 5, the button sending the at least one event when a user changes position of the button to request a scale change.

8. The method of claim 7, wherein the change of position by the user comprises dragging the position of the button along a portion of the graphical user interface to request a scale change, the button sending a plurality of events as a result of such dragging, each of the plurality of events indicating a substantially consecutive change in the scale of the image.

9. The method of claim 8, wherein the button comprises the ruler responding to one or more mouse events on the ruler.

10. The method of claim 5, comprising changing the denomination of distance indicators for the marks on the ruler at predetermined scale changes.

11. The method of claim 5, wherein the map comprises a MovieClip object.

12. A method of providing directional orientation in an electronic map, comprising:
storing data indicating true north, south, east and west for one for regions on the map;
storing data indicating local perceptions of north, south, east and west for the regions;
relating the local perceptions to the regions;
when each region is displayed, providing a toggle between displaying the region with true north of the region at an angle of 0 degrees orientation, or displaying the region at an angle with the local perception of north at an angle of 0 degrees orientation.

13. The method of claim 12, wherein at least one of the stored local perceptions of north is based on the named directions of local streets in the relative region.

14. The method of claim 12, wherein each of the stored local perceptions comprise an offset angle to define an angle of offset from north displayed at 0 degrees at which to display the region.

15. The method of claim 12, comprising rotating one or more labels on the map each time the map is toggled between displaying true north and perceived north at the angle of orientation of 0 degrees to thereby provide a constant horizontal display of the one or more labels.

16. A method of maintaining horizontal display of one or more labels in an image, comprising:
rotating the image by changing the angle of display of the image each time in response to one of a plurality of events; and
redrawing the one or more labels in response to each event;
thereby providing for a smooth adjustment of each label to maintain a horizontal status.
